(19) United States
(12) Patent Application Publication
(10) Pub. No.: US 2002/0090158 A1
(43) Pub. Date: Jul. 11, 2002

(54) Wheel support assembly for transmitting a drive force from an electric motor to a wheel

(75) Inventors: Takashi Nozaki, Iwata-shi (JP); Masuo Takaki, Osaka (JP)

Correspondence Address: SUGHRUE MION, PLLC, 2100 Pennsylvania Avenue, NW, Washington, DC, 20037-3213, US

(73) Assignee: NTN CORPORATION

(21) Appl. No.: 10/013,552

(22) Filed: Dec. 13, 2001

(30) Foreign Application Priority Data
Dec. 14, 2000 (JP) 2000-379733

(51) Int. Cl. F16C 13/00

(52) U.S. Cl. 384/544

(57) ABSTRACT

A wheel bearing assembly for transmitting an automotive drive force from an electrically operated drive motor (1) to a wheel (52) is designed to have a compact and lightweight structure and to enable standardization of assemblage of electric motorcars. The wheel bearing assembly includes an outer member (41) formed integrally with a radially outwardly extending flange (44) for securement of the assembly to an automotive fame structure, and an inner member (42) having a center bore (49) and adapted to be driven by the drive motor 1 through an axle (60) fixedly inserted into the center bore (49). Each of the inner and outer members (41) and (42) has two raceways with respective rows of rolling elements (43) intervening therebetween. The inner member (42) has a radially outwardly extending wheel mounting flange (42) to which the wheel (52) is secured.

### BACKGROUND OF THE INVENTION

1. Field of the Invention

The present invention generally relates to an electric motorcar system and, more particularly, to a wheel bearing assembly for transmitting an automotive drive force, generated by an electrically operated drive motor, to a wheel to drive the latter.

2. Description of the Prior Art

In view of the demanding reduction of the environment pollutants and the availability of the limited resources, development of electric motorcars powered by an electrically operated drive motor in place of the conventional combustion engine has come to be centered in recent years. As regards the drive transmission system employed in the electric motorcars, some of the electric motorcars employ a direct connection system in which the electrically operated drive motor is drivingly coupled direct with the wheels and some of them are based on a drive transmission system generally employed in association with the combustion engine powered automobiles. By way of example, except that the electrically operated drive motor supersedes the combustion engine, the drive transmission system employed in most electric motorcars is similar or substantially identical with that employed in association with the combustion engine powered automobiles with or without the transmission replaced with a reduction gear train.

Even in the wheel bearing assembly for use in the electric motor cars, the drive transmission system based on that used in association with the combustion engine powered automobiles is generally of a design in which the automotive drive force generated by the electrically operated drive motor is transmitted to a wheel hub, which is a rotating member of the wheel bearing assembly, through a differential. gear, then through a constant velocity universal joint of a slidable type, an intermediate shaft and finally through a constant velocity universal joint of a fixed type.

However, in the electric motorcar, the capacity of an accumulator or a storage battery is so limited that the consumption of an electric power available from the accumulator is required to be minimized, and reduction in weight of the electric motorcar as compared with that of the combustion engine powered automobile is demanding. Because of is, various component parts of the electric motorcar are required to be manufactured compact in structure and light in weight, and demands are increasing to reduce the weight of the wheel bearing assembly and also to compactize the wheel bearing assembly.

On the other hand, in order to increase the productivity by standardizing assembly lines for the manufacture of electric motorcars, it is indeed undesirable, and should even be avoided, to use specially designed component parts which would otherwise require modification or reformation of the assembly line. For this reason, it is keenly desired to develop a unique wheel bearing assembly for the electric motorcar that is quite different from that used in the combustion engine powered automobile.

### SUMMARY OF THE INVENTION

Accordingly, a primary object of the present invention is to provide an improved wheel bearing assembly which have a compact and lightweight structure and which contributes to standardization of assemblage of electric motorcars.

In order to accomplish the foregoing object, he present invention in accordance with one aspect thereof provides a wheel berg assembly in a drive transmission system for transmitting an automotive drive force, generated by an electrically operated drive motor, to a wheel supported by the wheel beating assembly, which assembly includes:

an outer member having an outer periphery formed integrally with a radially outwardly extending flange and an inner periphery formed with a plurality of circumferentially extending outer raceways;

a generally annular inner member having inner raceways defined in an outer periphery thereof in alignment with the outer raceways and also having a center bore defined therein and adapted to receive an axle therein for rotation together therewith; and

circumferential rows of sets of rolling elements one set for each row intervening between the outer raceways in the outer member and the inner raceways in the inner member;

wherein said inner member is driven by the automotive drive force generated by the electrically operated drive motor and transmitted thereto through the axle.

With the wheel support assembly so constructed as hereinabove described the inner member can be driven by the automotive drive force, generated by the electrically operated drive motor, through the axle and, hence, the wheel secured to the inner member is thus driven The outer member of the wheel support assembly is formed integrally with the flange on an outer periphery, and cart be secured to the automobile frame structure or chassis through such flange. Thus, since the inner member is formed integrally with the flange no ring member which would otherwise required to mount the outer member of the wheel support assembly to the automobile frame structure or chassis is needed and, hence, a wheel beating assembly carrier such as, for example, a knuckle provided on the automobile frame structure can have a simplified and compact structure thereby contributing to reduction in weight of the electric motorcar as a whole. Also, unlike the design in which the outer member is integrated with the wheel bearing assembly carrier such as the knuckle, which would require a specially designed automobile production line, the present invention eliminates the need to use the specially designed automobile production line and standardization of the automobile production lines can easily be attained.

The inner member may be formed with a wheel mounting flange. This advantageously makes it possible to simplify the structure required to secure the wheel to the inner member and, hence, a mechanism including the wheel bearing assembly and component parts peripheral to the wheel bearing assembly can advantageously be manufactured lightweight.

Also, the inner member may include a hub member and a bearing inner race member mounted externally on the hub member. In such case, the bearing inner race member may be held on the hub member iii an axially immovable fashion by a crimped plug. Where the bearing inner race is fixedly mounted on the hub member while kept in position by the crimped plug, the bearing inner race member can be positioned with a simplified structure, thereby contributing to reduction in weight and cost.

The present invention in accordance with another aspect thereof provides a wheel bearing assembly in a drive transmission system for transmitting an automotive drive force, generated by an electrically operated drive motor, to a wheel supported by the wheel bearing assembly, which assembly includes:

an outer member having an outer periphery formed integrally with a radially outwardly extending flange and an inner periphery formed with a plurality of circumferentially extending outer raceways;

an inner member having inner raceways defined in alignment with the outer raceways, said inner member being integrated together with an outer coupling member formed with a plurality of circumferentially spaced track grooves for guiding corresponding torque transmitting balls used in a constant velocity universal joint; and

circumferential rows of sets of rolling elements one set for each row intervening between the outer raceways in the outer member and the inner raceways in the inner member;

wherein said inner member is driven through the outer coupling member by the automotive drive force generated by the electrically operated drive motor.

Where the wheel bearing assembly and the outer coupling member that is a component part of the constant velocity universal joint are integrated together as described above, further compactization and reduction in weight are possible along with reduction in number of assembling steps. Also, by the reason similar to that described in connection with the wheel bearing assembly according to the first mentioned aspect of the present invention, the assembly line for the manufacture of the electric motorcars can easily be standardized.

In the wheel bearing assembly according to any one of the first and second mentioned aspects of the present invention, the drive motor may be powered by an electric power generated by a fuel cell.

Where the fuel cell is used, there should hardly be any problem associated with exhaust gases and an excellent mileage can be appreciated. The use of a motor drive system in which the drive motor is powered by an electric power generated by the fuel cell in combination with the wheel bearing assembly of the structure described above effectively results in reduction in weight and, therefore, the electric motorcar can give rise to an excellent performance.

Also, in the wheel bearing assembly according to any one of die first and second mentioned aspects of the present invention, the inner member may be driven by, in addition to the automotive drive force generated from the drive motor, an automotive drive force generated by an combustion engine. This hybrid system makes it possible to utilize advantages afforded by the use of the combustion engine and that of the electrically operated drive motor and, even in this case, effects brought about by the use of the wheel berg assembly of tie structure described above are remarkable.

### BRIEF DESCRIPTION OF THE DRAWINGS

In any event, the present invention will become more clearly understood from the following description of preferred embodiments thereof when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a longitudinal sectional view, showing a wheel bearing assembly for transmitting an electrically powered drive force to one of automotive wheels in accordance with a preferred embodiment of the present invention.

FIG. 2 is a longitudinal sectional view of a drive axle system of an electric motorcar including the wheel bearing assembly for each of the drive wheels;

FIG. 3 is a longitudinal sectional view of a constant velocity universal joint of a slidable type;

FIGS. 4A and 4B are front elevational views showing different examples of an outer coupling member employed in the constant velocity universal joint of the slidable type;

FIG. 5 is a longitudinal side view, with a portion out out of the constant velocity universal joint of a fixed type;

FIG. 6 is a longitudinal sectional view of a modified form of the wheel bearing assembly;

FIG. 7 is a longitudinal sectional view of the wheel bearing assembly according to another preferred embodiment of the present invention;

FIG. 8 is a longitudinal section view of the wheel bearing assembly according to a further preferred embodiment of the present invention;

FIG. 9 is a longitudinal sectional view of the wheel bearing assembly according to a still further preferred embodiment of the present invention;

FIG. 10 is a schematic layout diagram showing a wheel support and drive system to which the wheel bearing assemblies of the present invention are applicable;

FIG. 11 is a schematic layout diagram showing a modified form of the wheel support and drive system;

FIG. 12 is a schematic layout diagram showing a further modified form of the wheel support and drive system; and

FIG. 13 is a schematic layout diagram showing a still further modified form of the wheel support and drive system.

### DETAILED DESCRIPTION OF THE EMBODIMENTS

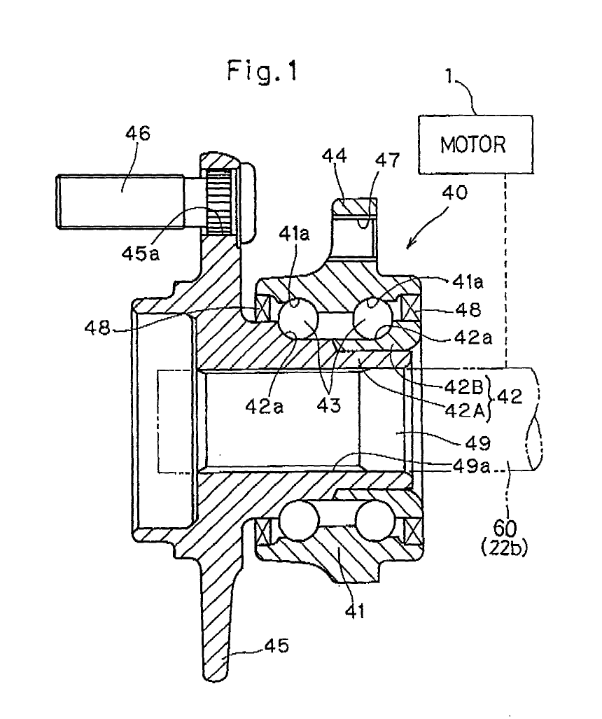

Preferred embodiments of the present invention will now be described individually with reference to the accompanying drawings. Of those drawings, FIG. 1 illustrates, in a longitudinal sectional representation, an example of a wheel bearing assembly for transmitting an electrically powered drive force to one of automotive wheels. This illustrated example corresponds to what is referred to as a wheel bearing assembly of a third generation for an automotive vehicle utilizing a combustion engine. The illustrated wheel bearing assembly, generally identified by 40, includes an outer member 4, an inner member 42 and a plurality o, for example, two rows of sets of rolling elements 43 one set for each row intervening between the outer and inner members 41 and 42. The inner member 42 is positioned inside tie outer member 41 so as to define an annular space, opposite annular ends of such annular space being sealed by respective sealing members 48. Each row of the rolling elements 43 are retained by a corresponding retainer or cage (not shown).

The outer member 41 has its outer peripheral surface formed integrally with a radially outwardly extending flange 44 and its inner peripheral surface formed with circumferentially extending annular rolling raceways 41a equal in number to the number of the rows of the rolling elements 43.

The inner member 42 is in the form of an annular member having rolling raceways 42a defined in an outer peripheral surface thereof so as to extend circumferentially thereof and aligned with the associated annular rolling raceways 41a in the outer member 41. The inner member 42 includes a hub member 42A, a bearing inner race member 42b and a wheel mounting flange 45. The hub member 42A is reduced it outer diameter thereof to provide a reduced diameter portion, and the bearing inner race member 42B referred to above is fixedly mounted on sold reduced diameter portion of the hub member 42A. Of the rolling raceways 42a and 42a, the rolling raceway 42a remote from the wheel mounting flange 45 is defied in the bearing inner race member 42B, whereas the remaining rolling raceway 42a adjacent the wheel mounting flange 45 is defined directly on the outer peripheral surface of the hub member 42A.

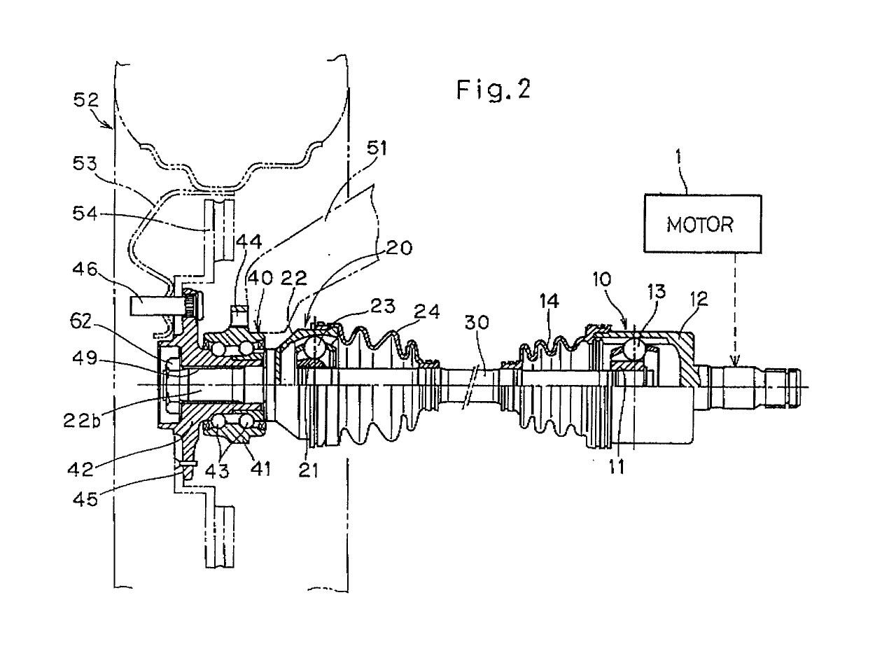

The inner member 42 has a center bore 49 defied therein over a length thereof and also has a plurality of circumferentially spaced serrations 49a formed in a portion of the inner peripheral surface thereof that is encompassed by the hub member 42A, so as to extend axially thereof The wheel mounting flange 45 referred to above is formed on the inner member 42 so as to extend radially outwardly from the other of the opposite ends of the inner member 42 remote from the berg inner race member 42B. This wheel mounting flange 45 is formed with a plurality of circumferentially spaced bolt hole 45a for receiving a corresponding number of bolts 46 (only one of which is shown in FIG. 1) that are used to secure thereto a corresponding tired wheel shown by the phantom line in FIG. 2.

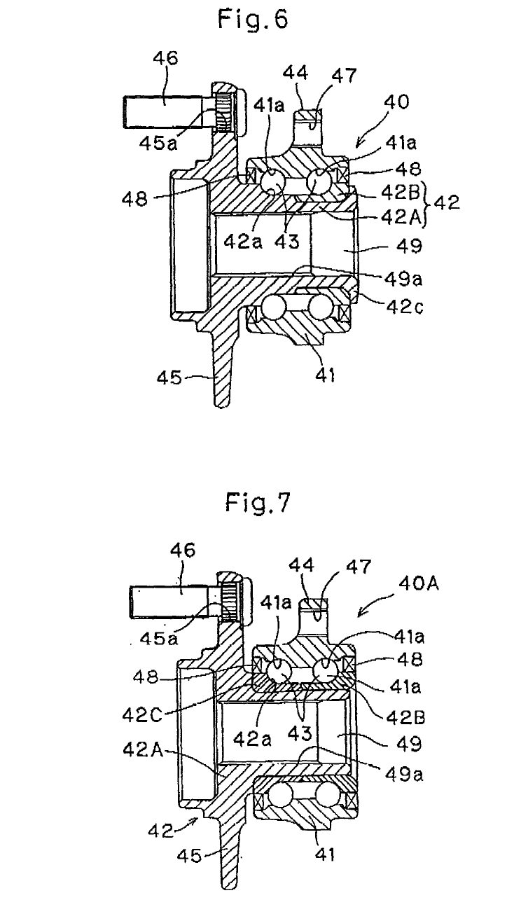

Although in the inner member 42 so far shown in the illustrated embodiment the bear inner race member 42B is fixedly mounted on the hub member 42A under interference fit, any other fixing means may be employed. By way of example, as shown in FIG. 6, the bearing inner race member 42B may be fixedly mounted on the hub member 42A by staking or crimping that end portion of the hub member 42A, that protrudes axially outwardly from the bearing inner race member 421 on the hub member 42A, so as to protrude radially outwardly to thereby define an annular crimped plug 42c held in contact wit h an annular end face of the bearing inner race member 42B opposite the row of the rolling elements 43. Thus, the annular crimped plug 42c can be formed by flanging that end portion of the hub member 42A radially outwardly and this technique to form the annular crimped plug 42c is generally referred to as a rolling crimping. In this way, the bearing inner race member 42B is held on the hub member 42A in an axially immovable fashion.

Referring still to FIG. 1, the inner member 42 has a drive axle 60 inserted into the center bore 49. This inner member 42 is driven by an electrically operated drive motor 1, providing an automotive drive force, through the drive axle 60. As a matter of course, that end portion of the drive axle 60 that is inserted into center bore 49 is formed with circumferentially spaced, axially extending serrations complemental to the serrations 49a in the center bore 49.

The wheel bearing assembly 40 of the structure described above is so designed and so configured tat the inner member 42 can be driven by the automotive drive force, generated by the electrically powered drive motor 1, through the drive axle 60 to thereby rotate the tired wheel. On the other hand, the outer member 41 has its outer peripheral surface formed integrally with the radially outwardly ending flange 44 through which the wheel bearing assembly 40 of the present invention can be secured to an automobile frame structure or chassis. Since the flange 44 is so formed integrally with the outer member 41, no extra ring-shaped element is needed that would be used to mount the outer member 41 of the wheel bearing assembly 40 to the automobile frame structure and, accordingly, a wheel bearing assembly carrier (for example, a component shown by 51 by the phantom lie in FIG. 2) such as, for example, a knuckle provided on the automobile frame structure can have a simplified and compact structure, thereby contributing to reduction in weight of the electric motorcar as a whole. Also, unlike the design in which the outer member 41 is integrated with the wheel bearing assembly carrier such as the knuckle, which would require a specially designed automobile production line, the present invention eliminates the need to use the specially designed automobile production line and standardization of the automobile production lines can easily be attained.

In addition, in the case of the illustrated embodiment since the wheel bearing assembly is of a design corresponding to the so-called third generation and since one of the rolling raceways 42a is formed directly on the hub member 42A, any possible loss of the automotive drive force which would be otherwise brought about by a dragging torque can advantageously be lessened, making it possible for the electric motorcar to be operated over an increased travel distance.

FIG. 2 illustrates an example of the drive axle system of the electric motorcar utilizing the wheel bearing assembly 40 of the structure described above. The illustrated drive Axle system includes, in addition to the electrically operated drive motor 1, a constant velocity universal joint 10 of a slidable type, a constant velocity universal joint 20 of a fixed type, an intermediate shaft 30 and a wheel bearing assembly.

The wheel bearing assembly 40 is firmly secured to the wheel bearing assembly carrier 51 such as a knuckle, rigid with the automobile frame structure or chassis (not shown), with the flange 44 of the outer member 41 bolted thereto by means of a plurality of bolts (not shown). The tired wheel 52 is secured to the inner member 42. The tired wheel 52 has a rim portion 53 secured to the wheel mounting flange 45 integral with the inner member 42, together with a brake disc 54 by means of the bolts 46.

The constant velocity universal joint 10 of the slidable type includes a first inner coupling member 11, a fist outer coupling member 12 and a first torque transmitting member 13. On the other hand, the constant velocity universal joint 20 of (he fixed type includes a second inner coupling member 21, a second outer coupling member 22 and a second torque transmitting member 23.

The intermediate shaft 30 has its opposite ends connected with the first inner coupling member 11 of the slidable constant velocity universal joint 10 and the second inner coupling member 21 of the fixed constant velocity universal joint 20, respectively. The first outer coupling member 12 of the slidable constant velocity universal joint 10 and the second outer coupling member 22 of the fixed constant velocity universal joint 20 are provided with respective flexible tubular boots 14 and 24 so as to cover the corresponding end portions of the intermediate shaft 30.

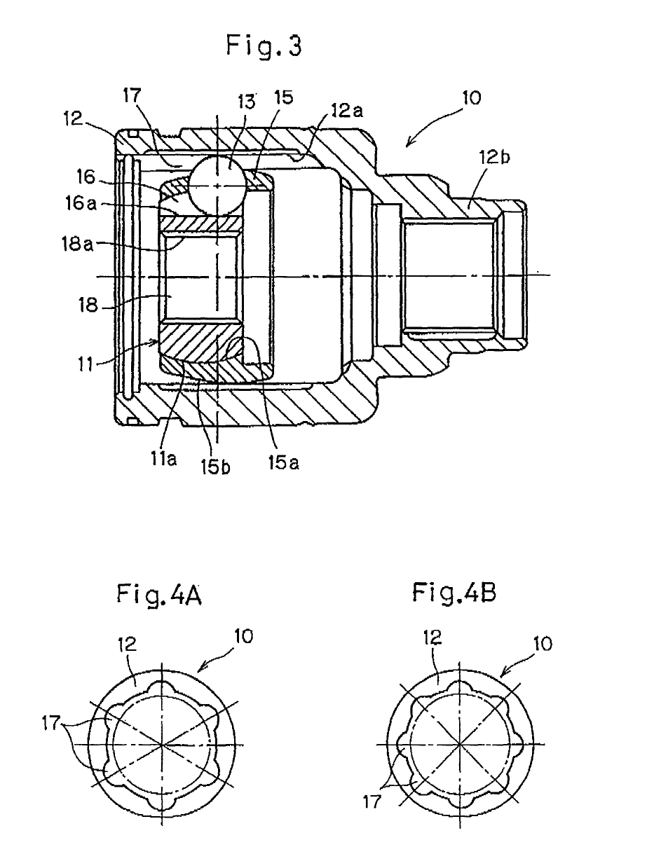

FIG. 3 illustrates the details of the slidable constant velocity universal joint 10 This slidable constant velocity universal joint 10 is of a structure wherein the first inner coupling member 11 is in the form of an annular member having a spherical outer surface 11a formed with a plurality of axially extending and circumferentially spaced track grooves 16; the first outer coupling member 12 is in the form of a generally cylindrical hollow member having a cylindrical inner surface 12a formed with axially extending track grooves 17 that are cooperable with the respective track grooves 16 in the first inner coupling member 11; and ball elements forming the first torque transmitting member 13 are interposed between the first inner and outer coupling members 11 and 12 with each ball element movable received in part within the corresponding track 25 groove 16 and in part within the corresponding track groove 17. Each of the axially extending tack grooves 16 defined in the inner coupling member 11 has a groove bottom 16a extending straight as viewed in a longitudinal sectional representation thereof and as clearly shown in FIG. 3.

The ball elements forming the first torque transmitting member 13 are orderly retained by a ball retainer or cage 15 of a structure having a spherical inner surface 15a slidingly guided by the spherical outer surface 11a of the inner coupling member 11, and a spherical outer surface 15b slidingly guided by the cylindrical inner surface 12a of the outer coupling member 12. The spherical inner and outer surfaces 15a and 15b of the ball retainer 15 have respective centers of curvature that are offset a predetermined distance in a direction axially of the inner coupling member 11 and, hence, forming the slidable constant velocity universal joint 10.

The inner coupling member 11 has an inner bore 18 having a plurality of circumferentially spaced serrations 18a formed on an inner peripheral surface thereof so as to extend axially thereof On the other hand, that end of the intermediate shaft 30 coupled with the slidable constant velocity universal joint 10 as shown in FIG. 2 has its peripheral surface formed with corresponding serrations and is inserted into the inner bore 18 of the inner coupling member 11 for rotation together therewith. The outer coupling member 12 is formed so as to represent a shape similar to the shape of a cup having a stud shaft 12b formed integrally therewith so as to extend outwardly from a bottom of the cup-shaped outer coupling member 12. The stud shaft 12b is in turn adapted to receive the automotive drive force from a drive source such as the electrically operated drive motor 11. The stud shaft 12b may be drivingly connected with the drive motor 11 through a differential gear assembly

The number of the track grooves 17 (as well as that of the track grooves 16) in the slidable constant velocity universal joint 10 may be six such as shown in FIG. 4A or eight such as shown in FIG. 4B. Where the eight track grooves 17 are employed, the slidable constant speed universal joint 10 can be assembled compact in structure and light in weight due to the reduction of diameter of the ball element 13 (FIG. 3) Also, although. the slidable constant velocity universal joint 10 has been described and shown as a type employing the ball elements for the torque transmitting member 13, it should be noted that a constant velocity universal joint of a tripod type employing three trunnion shafts can be equally employed.

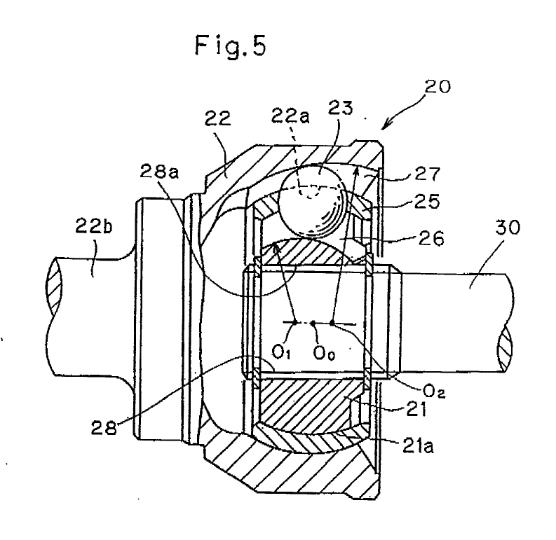

The details of the constant velocity universal joint 20 of the fixed type are shown in FIG. 5. This fixed constant velocity universal joint 20 is of a structure wherein the second inner coupling member 21 is in the form of an annular member having a spherical outer surface 21a formed with a plurality of axially extending and circumferentially spaced track grooves 26; the second outer coupling member 22 is in the form of a generally cylindrical hollow member having a cylindrical inner surface 22a formed with axially extending track grooves 27 that are cooperable with the respective track grooves 26 in the second inner coupling member 21; and ball elements forming the second torque transmitting member 23 are interposed between the second inner and outer coupling members 21 and 22 with each ball element movable received in part within the corresponding tack groove 26 and in part within the corresponding track groove 27. The ball elements forming the first torque transmitting member 23 are orderly retained by a ball retainer or cage 25 of a structure having spherical inner and outer surfaces slidingly guided by the spherical outer and inner surfaces 21a and 22a of the inner and outer coupling members 21 and 22, respectively.

Each of the axially extending track grooves 26 defied in the inner coupling member 21 has a groove bottom shaped spherical as viewed in a longitudinal sectional representation thereof and as clearly shown in FIG. 5, a center of curvature of which is indicated by O₁. Similarly, each of the axially extending track grooves 27 defined to the outer coupling member 22 has a groove bottom shaped spherical, a center of curvature of which is indicated by O₂. It is to be noted that the centers of curvatures O₁ and O₂ of the spherically curved groove bottoms of the track grooves 26 and 27 are positioned on respective sides of and offset a predetermined distance from a joint center angle O₀ in a direction axially of the fixed constant velocity universal joint 20, respectively. The Joint center angle O₀ referred to above occupies a position coincidence with the center of curvature of each of the spherical outer surface 21a of the inner coupling member 21 and the spherical inner surface 22a of the outer coupling member 22.

The inner coupling member 21 has a cylindrical bore 28 having a plurality of circumferentially spaced serrations 28ₐ formed on an inner peripheral surface thereof so as to extend axially thereof On the other band, that end of the intermediate shaft 30 remote from the. slidable constant velocity universal joint 10 has its peripheral surface formed with corresponding serrations and is inserted into the cylindrical bore 28 of the inner coupling member 21 for rotation together therewith. The outer coupling member 22 is formed so as to represent a shape similar to the shape of a cup having a stud shaft 22b formed integrally therewith so as to extend outwardly from a bottom of the cup-shaped outer coupling member 22.

It is to be noted that the number of the track grooves 27 (as well as that of the track grooves 26) in the fixed constant velocity universal joint 20 may be six or eight as is the case with that in the slidable constant velocity universal joint 10. Where the eight track grooves 27 are employed, the fixed constant speed universal joint 20 can be similarly assembled compact in structure and light in weight

The stud shaft 22b extending axially outwardly from the bottom of the cup-shaped outer coupling member 22 as hereinabove described forms the drive axle 60 that has been described as inserted into the center bore 49 of the inner member 42 of the wheel bearing assembly 40 with reference to FIG. 2. A free end of the stud shaft 22b or the drive axle 60 is formed with a helical male thread so that a fastening nut 62 can be fastened thereto after it has been inserted through the center bore 49 of the inner member 42 as shown in FIG. 2.

From the foregoing description, it will readily be understood that the automotive drive force generated from the electrically operated drive motor 1 and transmitted to the slidable constant velocity universal joint 10 is transmitted to the inner member 42 of the wheel bearing assembly 40 through the intermediate shaft 30 and then through the fixed constant. velocity universal joint 20 to thereby drive the fired wheel 52 then secured to the inner member 42.

In another preferred embodiment of the wheel bearing assembly shown by 40A in FIG. 7, the wheel bearing assembly 40A shown therein corresponds to what is referred to as the second generation wheel bearing assembly. This wheel bearing assembly 40A is of a design in which two bearing inner races 42B and 42C each having a corresponding rolling raceway 42a defined therein are mounted on the hub member 42A in end-to-end abutment with each other to thereby define the inner member 42. Other structural features of the wheel bearing assembly 40A are similar to those of the previously described wheel bearing assembly 40 and, are not therefore reiterated for the sake of brevity. As a matter of course, the inner member 42 having the bearing inner races 42B and 42C is rotated by the axle (60 shown in FIG. 2) that is inserted into the center bore 49 and coupled by serrations.

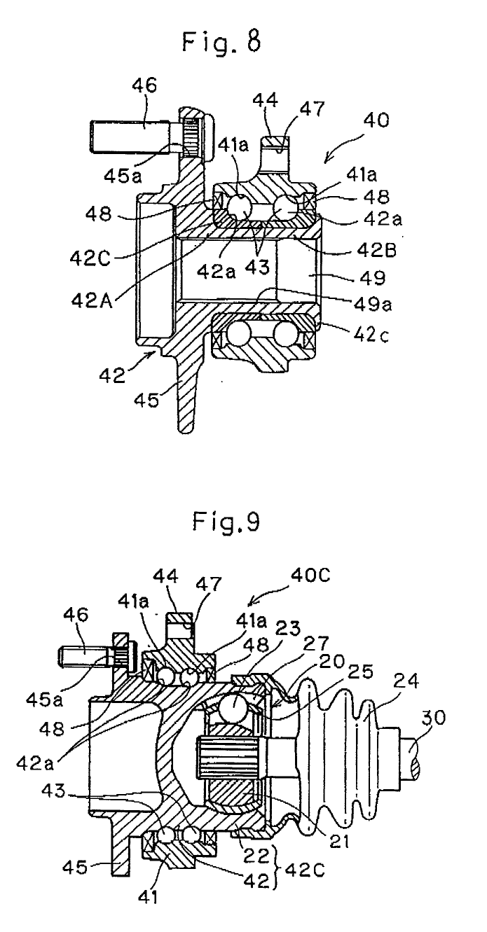

Even in this so-called second generation wheel bearing assembly 40A, fixed mounting of the bearing inner races 42B and 42C may be accomplished by the utilization of the annular crimped plug 42C, as shown in FIG. 8, in a manner similar to that described with reference to FIG. 6.

A Her preferred embodiment of the wheel bearing assembly of the present invention is shown by 40C in FIG. 9. The wheel bearing assembly 40C shown therein corresponds to what is referred to as the fourth generation wheel bearing assembly in the field of the combustion engine automobiles. This wheel bearing assembly 40C is of a design In which the inner member 42 thereof is integrated together with the second outer coupling member 22 of the fixed constant velocity universal joint 20 to thereby define a combination bearing and coupling member 42C.

The outer member 41 of the wheel bearing assembly 40C and the inner coupling member 21, the ball retainer 25 and the torque transmitting member 23 of the fixed constant velocity universal joint 20 are similar to that of the wheel bearing assembly 40, shown in and described width reference to FIG. 1, and those of the fixed constant velocity universal joint 20 shown in and described with reference to FIG. 5 respectively.

The combination bearing and coupling member 42C has a cylindrical outer peripheral surface formed with a plurality of, for example, two circumferentially extending raceways 42a and 42a and includes two rows of sets of rolling elements 43 one set for each tow intervening between the combination bearing and coupling member 42C and the outer member 41 with the rolling elements 43 of each row being received in part in the associated raceway 42a and in part in the corresponding raceway 41a in the outer member 41. This combination bearing and coupling member 42C is formed with the wheel mounting flange 45 protruding radially outwardly from one end thereof opposite to the outer member 41. The spherical inner surface and the track grooves 27 that form respective parts of the outer coupling member of the fixed constant velocity universal joint 20 are formed in an inner peripheral surface of the opposite end of the combination bearing and. coupling member 42C.

Thus, where the wheel bearing assembly 40 and the component parts of the fixed constant velocity universal joint 20 are integrated together to define the combination bearing and coupling member 42C, not only can further compactization and reduction in weight be achieved, but the number of assembling steps can also be reduced.

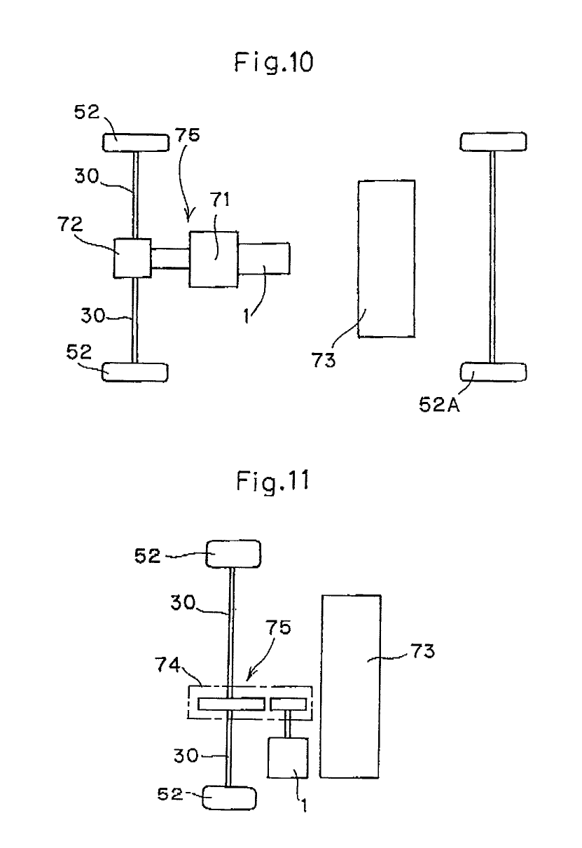

With reference to FIGS. 10 to 13, some examples of a wheel support and drive systems for transmitting the automotive drive force from the electrically operated drive motor 1 to the wheel bearing assembly will be described.

The wheel support and drive system shown m FIG. 10 is similar to that employed in association with the combustion engine powered automobile, except that the combustion engine is replaced with the electrically operated drive motor 1. In the system shown in FIG. 10, the automotive drive force from the electrically operated drive motor 1 is transmitted to the intermediate shafts 30 through a drive transmission system 75 including a transmission 71 and a differential gear assembly 72. The electrically operated drive motor 1 employed in the system of FIG. 10 is powered by an electric power supplied from an accumulator or storage battery 73. The transmission 71 forming a part of the drive transmission system 75 may be either a manual shift gear assembly or an automatic shift gear assembly utilizing a torque converter.

The electric motorcar substantially as shown in FIG. 10 includes, in addition to the tired wheels 52 drivingly coupled with the drive motor 1 in the manner hereinabove discussed, a pair of tired driven wheels 54A. Of these tired wheels, the tired drive wheels 52 are drivingly supported by the respective wheel bearing assemblies according to any one of the foregoing preferred embodiments of the present invention described with reference to FIGS. 1 to 9 with the automotive drive force from the drive motor l being transmitted to the inner members of the wheel bearing assemblies by way of the respective intermediate shafts 30. Where the drive axle system, show in FIG. 2 is employed in association with each of the tired wheels 52, the automotive drive force from the drive motor 1 is transmitted to the respective first outer members 12 of the slidable constant velocity universal joints 10 through the differential gear assembly 72.

It is to be noted that in the wheel support and drive system shown in FIG. 10, techniques utilized in connection with the combustion engine powered automobiles can be employed with no slight modification.

The wheel support and drive system shown in FIG. 11 is similar to that employed in association with the combustion engine powered automobile, except that the combustion engine is replaced with the electrically operated drive motor 1 and the transmission is replaced with a reduction gear train. In this wheel support and drive system, the automotive drive force from the electrically operated drive motor 1 is transmitted to the intermediate shaft 30 through the reduction gear train 74. The reduction gear train 74 may be employed in the form of, for example a fixed reduction gear unit having a fixed gear ratio. The transmission system 75 may be of either a type including a reduction gear train 74 or a type including a combination of the reduction gear train 74 and a differential gear assembly (not shown). As a matter of course, the drive motor 1 is powered by an electric power supplied from the accumulator or storage battery 73.

As compared with the combustion engine, the electrically operated drive motor 1 is easy to control and, therefore, even though the reduction gear train 74 of a fixed gear ratio is used, the fired drive wheels 52 can be properly and easily maneuvered. Thus, the use of the reduction gear train 74 discussed hereinabove is advantageous in that it can considerably contribute to reduction in weight of the electric motorcar as compared With the use of the transmission.

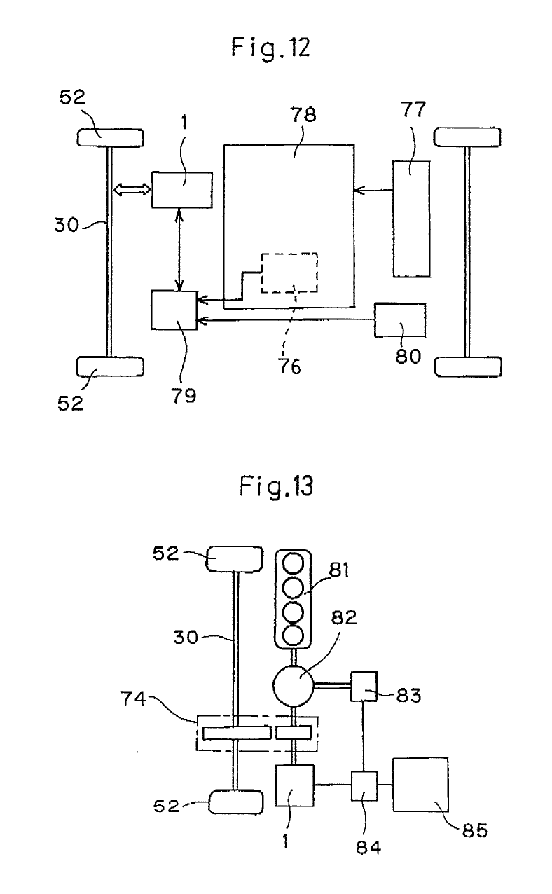

The wheel support and drive system shown in FIG. 12 is of a design in which the electrically operated drive motor 1 is powered by an electric power supplied from a fuel cell 76. The fuel cell 76 makes use of a fuel such as, for example, hydrogen gas, methanol or gasoline contained in a fuel tank 77 to generate an electric power through a chemical reaction. The fuel cell 76 together with a methanol reformer and an air compressor (both not shown) constitute a part of a fuel cell power unit 78. The electric power generated from the fuel cell 76 is supplied to the drive motor 1 through an electric power control unit 79. The electric power control unit 79 can also be used to supply the electric power from the accumulator or storage battery 80 in a controlled manner to the drive motor 1. The drive motor 1 is of a type capable of concurrently serving as a dynamo-electric generator so that when the electric motorcar is braked the regenerated electric power can be used to charge the accumulator or storage battery 80.

The wheel support and drive system shown in FIG. 13 is of a hybrid type m which both the electric drive motor and any known combustion engine are employed one at a time to drive the wheels 52. In this wheel support and drive system, the combustion engine shown by 81 is powered by gasoline or petrol and serves as a prime mover to produce the drive force that is transmitted to the tired drive wheels 52 through a drive power divider 82 and a reduction gear train 74. The electrically operated drive motor 1 is an auxiliary mover and provides the drive force that is transmitted to the tired drive wheels 52 through the reduction gear train 74 that is used in a transmission path from the combustion engine 81. The drive force of the combustion engine 81 divided by the drive power divider 82 is used to drive a dynamo-electric generator 83 which. in turn provides an electric power to be supplied to the electrically operated drive motor 1 through an inverter 84. The accumulator or storage battery 85 is capable of supplying an electric power to the drive motor 1 through the inverter 84, and the electric power generated from the drive motor 1 during the braking of the electric motorcar can be stored in the accumulator or storage battery 85 through the inverter 84.

Although the present invention has been fully described in connection with the preferred embodiments thereof with reference to the accompanying drawings which are used only for the purpose of illustration, those skilled in the art will readily conceive numerous changes and modifications within the framework of obviousness upon the reading of the specification herein presented of the present invention. By way of example, although the rolling elements 43 employed in the wheel bearing assembly 40 have been shown and described as employed in the form of balls, tapered rollers may be equally employed in place of the balls.

Accordingly such changes and modifications are, unless they depart from the scope of the present invention as delivered from the claims annexed hereto, to be construed as included therein.

What is claimed is:

1. A wheel bearing assembly in a drive transmission system for transmitting an automotive drive force, generated by an electrically operated drive motor, to a wheel supported by the wheel bearing assembly, said wheel bearing assembly comprising:
an outer member having an outer periphery formed integrally with a radially outwardly extending flange and an inner periphery formed with a plurality of circumferentially extending outer raceways;
a generally annular inner member having inner raceways defined in an outer periphery thereof in alignment with the outer raceways and also having a center bore defined therein and adapted to receive an axle therein for rotation together therewith; and
circumferential rows of sets of rolling elements one set for each row intervening between the outer raceways in the outer member and the inner raceways in the inner member;
wherein said inner member is driven by the automotive drive force generated by the electrically operated drive motor and transmitted thereto through the axle.

2. The wheel bearing assembly as claimed in claim 1, wherein the inner member is formed with a wheel mounting flange.

3. The wheel bearing assembly as claimed in claim 1, wherein the inner member includes a hub member and a bearing inner race member mounted externally on the hub member, said bearing inner race member being held on the hub member in an axially immovable fashion by a crimped plug.

4. The wheel bearing assembly as claimed in claim 1, wherein the drive motor is powered by an electric power generated by a fuel cell.

5. The wheel bearing assembly as claimed in claim 1, wherein the inner member is driven by, in addition to the automotive drive force generated from the drive motor, an automotive drive force generated by an combustion engine.

6. A wheel berg assembly in a drive transmission system for transmitting an automotive drive force, generated by an electrically operated drive motor, to a wheel supported by the wheel bearing assembly, said wheel bearing assembly comprising:
an outer member having an outer periphery formed integrally with a radially outwardly extending flange and an inner periphery formed with a plurality of circumferentially extending outer raceways;
an inner member hang inner raceways defined in alignment with the outer raceways, said inner member being integrated together with an outer coupling member formed with a plurality of circumferentially spaced track grooves for guiding corresponding torque transmitting balls used in a constant velocity universal joint; and
circumferential rows of sets of rolling elements one set for each row intervening between the outer raceways in the outer member and the inner raceways in the inner member;
wherein said inner member is driven through the outer coupling member by the automotive drive force generated by the electrically operated drive motor.

7. The wheel bearing assembly as claimed in claim 6, wherein the drive motor is powered by an electric power generated by a fuel cell.

8. The wheel beating assembly as claimed in claim 6, wherein the inner member is driven by, in addition to the automotive drive force generated from the drive motor, an automotive drive force generated by an combustion engine.
